(19) United States
(12) Patent Application Publication
(10) Pub. No.: US 2003/0235152 A1
(43) Pub. Date: Dec. 25, 2003

(54) Network system incorporating protection paths in the transmission bandwidth of a virtual concatenation signal

(75) Inventor: Yasuaki Shibasaki, Tokyo (JP)

Correspondence Address: YOUNG & THOMPSON, 745 SOUTH 23RD STREET 2ND FLOOR, ARLINGTON, VA, 22202

(73) Assignee: NEC CORPORATION, Tokyo (JP)

(21) Appl. No.: 10/465,584

(22) Filed: Jun. 20, 2003

(30) Foreign Application Priority Data
Jun. 21, 2002 (JP) 2002-181374

(51) Int. Cl. H04L 1/00

(52) U.S. Cl. 370/225; 370/404

(57) ABSTRACT

A method is disclosed for setting transmission routes in which the transmission bandwidth is expanded by incorporating in a virtual concatenation signal those protection paths that are in a normal standby state. A protection control means selects paths to use in accordance with the state of each path in a redundancy configuration that is realized by prescribed working paths and protection paths. A bandwidth management means receives the states of working paths and protection paths from the protection control means. The bandwidth management means then incorporates protection paths in a virtual concatenation signal that includes working paths if the protection paths are in a normal standby state. If the protection paths are in an unusable state or in a used state, the bandwidth management means constructs the virtual concatenation signal with only paths that can be used in virtual concatenation.

### BACKGROUND OF THE INVENTION

1. Field of the Invention

The present invention relates to an SDH ring network, and more particularly to an improvement of the reliability and efficiency of use of SDH network transmission paths.

2. Description of the Related Art

SDH (Synchronous Digital Hierarchy) is prescribed principally for the purpose of transmitting signals for speech services. In recent years, however, the amount of traffic for data services in addition to speech services has greatly increased, and the demand is therefore increasing for the more efficient transmission of signals for data service in an SDH network.

Data services, of which Ethernet is representative, are available at a variety of data rates. SDH of the prior art was not capable of efficiently accommodating the signals of these data services, and various attempts have therefore been made to efficiently accommodate the signals of data services in SDH. In ITU-T G. 707 and other standards, virtual concatenation technology has been proposed for efficiently accommodating in SDH signals of data service signals.

According to virtual concatenation, concatenating N (where N is any number) SDH paths enables the realization of a virtual concatenation signal having a transmission bandwidth that is any number of times (a. multiple of N) the transmission bandwidth of the SDH paths, and data services of various data rates can therefore be accommodated within an SDH network. Optical ring networks achieved by using SDH are already in use in many places due to their ease of maintenance and operation. Optical ring networks that are realized by means of SDH take various forms, but a network according to MS-SPRING (Multiplex Section Shared Protection Ring) recommended by ITU-T G. 841 can be offered as a representative example. In a MS-SPRING network, a plurality of nodes are connected by ring configuration transmission paths in which signals flow in different directions. The bandwidth of the transmission paths is evenly divided between a Working and a Protection band. In an MS-SPRING network, Working and Protection paths are provided between transmission side nodes and receiving side nodes. The working paths are set in the working bandwidth, and the protection paths are set in the protection bandwidth. When a fault occurs on a particular transmission path, data that were being transmitted on the working path that was set in this transmission path is switched to the protection path that corresponds to this working path, a function that is referred to as “protection.” By means of this protection, an MS-SP RING network achieves high reliability against faults. In order to guarantee this high reliability, however, half of the transmission bandwidth that is physically possessed by this MS-SP RING network is provided only for the event of a fault, and is thus reserved.

As represented by an MS-SPRING, half of the transmission bandwidth in an SDH ring system is typically maintained as protection for dealing with faults. Thus, a typical SDH ring system can use only half of the transmission bandwidth and makes inefficient use of the transmission bandwidth. In contrast, an SDH ring system can be considered that, by using the protection transmission bandwidth for service only when in a normal state that is free of faults, allows a more efficient use of the transmission bandwidth. In such a system, however, the occurrence of some type of fault on the transmission path and the consequent switching to the protection bandwidth would disconnect the service that was using this protection bandwidth.

As an example, it is possible to simply use the protection bandwidth together with the working bandwidth as the constituent elements of a virtual concatenation signal. A virtual concatenation signal is a channel in which the timings of a plurality of SDH paths are synchronized and in which the channels of these paths are logically linked. As a result, there is the problem that the occurrence of a fault on even one of the SDH paths that serve as the constituent elements in virtual concatenation will result in a fault of the entire virtual concatenation signal that contains the faulty SDH path. In this type of system, the execution of protection to continue providing service results in the interruption all services that were accommodated in the virtual concatenation signal that employed SDH paths in the protection bandwidth as constituent elements. Despite the difficulties encountered in simultaneously achieving both efficient use of the transmission bandwidth and reliability of the transmission paths as described in the foregoing explanation, there is a strong demand from network service providers for a new method that can achieve both goals.

### SUMMARY OF THE INVENTION

It is an object of the present invention to provide a network for accommodating data service and for realizing both efficient use of transmission bandwidth and reliability of a transmission path, and further, to provide a transmission device from which such a network is constructed.

To achieve the above-described object, a transmission device according to the present invention forms part of a network in which are applied: a virtual concatenation process for concatenating a plurality of paths to construct a single transmission bandwidth; and protection control for selecting paths that are used in accordance with the state of each of the paths in a redundancy configuration that is realized using a plurality of paths.

A protection control means executes protection control over prescribed working paths and protection paths and selects paths of either the prescribed working paths or protection paths. A bandwidth managing means operates in response to receiving the states of the working paths and protection paths from the protection control means. If protection paths are in a normal standby state, the bandwidth managing means incorporates the protection paths into a virtual concatenation signal that includes working paths. If a protection path is in an unusable state or a used state, the bandwidth managing means reconstructs the virtual concatenation signal only from paths that are selected by the protection control means. A path connection means receives working paths and protection paths as input and switches the connections of paths in accordance with control from the protection control means.

The present invention uses protection paths as the constituent elements of virtual concatenation during normal operation, thus efficiently utilizing the transmission bandwidth; and when a fault occurs in a working path, executes protection, and further, constructs a virtual concatenation signal only from paths that can be used in virtual concatenation, thus ensuring reliability in the event of a fault. As a result, the present invention can ensure compatibility between the efficient utilization of the transmission bandwidth and the reliability of the paths. The above and other objects, features, and advantages of the present invention will become apparent from the following description with reference to the accompanying drawings, which illustrate examples of the present invention.

### BRIEF DESCRIPTION OF THE DRAWINGS

FIG. 1 is a block diagram showing a network system of an embodiment in accordance with the present invention.

FIG. 2 is a block diagram showing a node of the present embodiment.

FIG. 3 is a sequence chart showing the operation of each part of a node when executing protection due to the occurrence of a fault in a transmission path.

FIG. 4 shows the operating state of a node in FIG. 2 when executing protection due to a fault in a transmission path.

FIG. 5 is a block diagram showing a node in another embodiment of the present invention.

FIG. 6 shows the operating state of a node in FIG. 5 when executing protection due to the occurrence of a fault in a transmission path.

FIG. 7 is a block diagram showing a network system of yet another embodiment of the present invention.

FIG. 8 is a block diagram showing a node shown in FIG. 7.

FIG. 9 shows the operating state of the node of FIG. 8 when executing protection due to the occurrence of a fault in a transmission path.

### DETAILED DESCRIPTION OF THE PREFERRED EMBODIMENTS

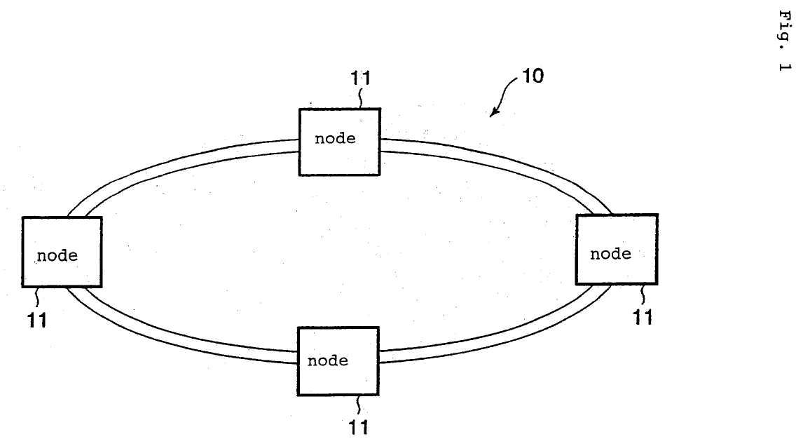

The network system of the present embodiment is an SDH ring system that is provided with the MS-SPRING capability, and further, that uses virtual concatenation process to accommodate data services. FIG. 1 is a block diagram showing the network system of this embodiment. Referring to FIG. 1, network system 10 is, as one example, a two-fiber (2F) MS-SPRING system and includes four nodes 11. All nodes 11 have the same configuration.

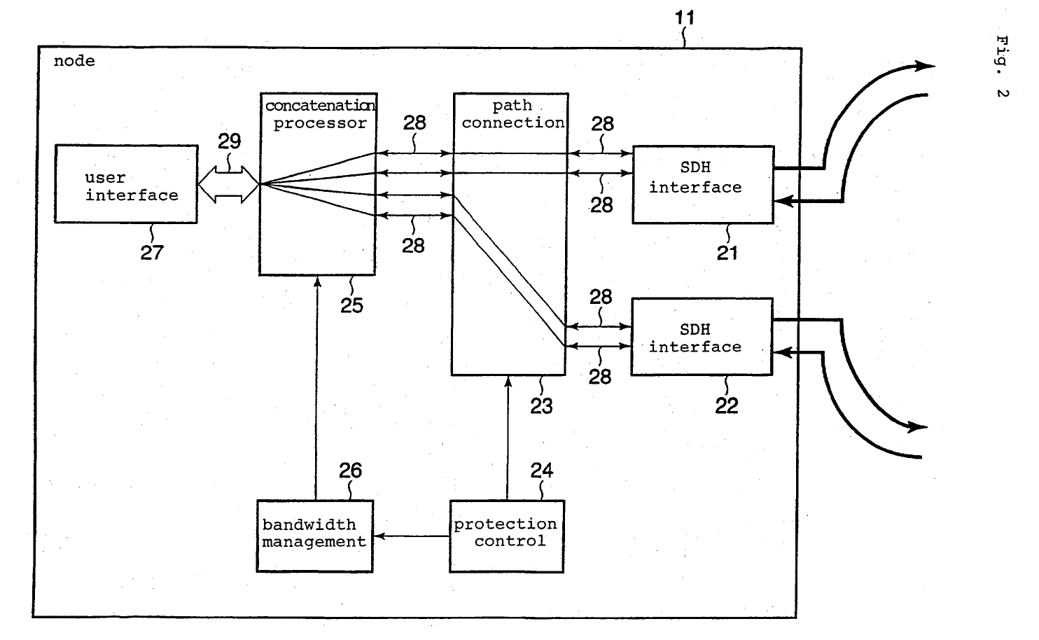

FIG. 2 is a block diagram showing a node of the present embodiment. Referring to FIG. 2, node 11 includes: SDH interfaces 21 and 22; path connection unit 23; protection control unit 24; concatenation processor 25; bandwidth management unit 26; and user interface 27.

SDH interfaces 21 and 22 interface with other adjacent nodes and transmit SDH lines that include a plurality of SDH paths to and from other nodes. SDH paths that are received at SDH interfaces 21 and 22 are supplied to path connection unit 23. In addition, SDH paths from path connection unit 23 are transmitted from SDH interfaces 21 and 22.

SDH interfaces 21 and 22 also monitor the state of the transmission paths and information on the SDH overhead for the receiving side of transmission paths. SDH interfaces 21 and 22 further send the state of each transmission path and information in the SDH overhead that is used in the protection protocol (hereinafter referred to as “protection information”) to protection control unit 24.

Upon receiving notification of execution of protection from protection control unit 24, SDH interfaces 21 and 22 report it to other neighboring nodes as protection information.

In accordance with path setting information from the host operating system (not shown in the figure), path connection unit 23 connects SDH interfaces 21 and 22 and concatenation processor 25 in units of SDH paths 28. The host operating system is a control system that, for example, monitors the network system 10 of the present embodiment for the purpose of operation and maintenance.

The host operating system is connected to a prescribed node and monitors and controls this node and other nodes. A DCC (Data Communication Channel) in the overhead of the SDH frames that are communicated between nodes may be used for monitoring and controlling other nodes.

In addition, path connection unit 23 changes connections between SDH interfaces 21 and 22 and concatenation processor 25 in accordance with instructions from protection control unit 24. Protection control unit 24 determines whether or not to execute protection based on the protection information and the state of each transmission path that is received from SDH interfaces 21 and 22. When protection is to be carried out, protection control unit 24 instructs path connection unit 23 to carry out protection (i.e., to change connections), and notifies SDH interfaces 21 and 22 and bandwidth management unit 26 regarding the SDH paths that are to be used in carrying out protection and the state of each SDH path. The protection that is carried out in this case is “ring protection.” Ring protection is a switching operation carried out in path units from working to protection paths between two nodes in a ring network. Switching paths between two nodes entails modifying the connection of path connections not only for the two nodes but also, according to necessity, for other nodes in network system 10.

Concatenation processor 25 links the plurality of SDH paths 28 between concatenation processor 25 and path connection unit 23 in accordance with the instructions from bandwidth management unit 26 and thus constructs virtual concatenation signal 29 between concatenation processor 25 and user interface 27.

Bandwidth management unit 26 instructs concatenation processor 25 to concatenate SDH paths 28 based on information that is notified from protection control unit 24. In a state in which working paths are selected and protection paths are in a normal standby state in protection control, the protection paths are included among the constituent elements of a virtual concatenation signal that includes working paths, whereby the transmission bandwidth of the protection paths is effectively utilized. When protection paths are selected and in a state of use in protection control, the virtual concatenation signal is constructed using only the selected protection paths. The selection and use of a protection path occurs when a fault has occurred on a working path or when an operator has forcibly selected the protection path. In addition, working paths are selected in protection control, and if protection paths are in an unusable state, the virtual concatenation signal is constructed only from working paths. An unusable state of a protection path is, for example, a state in which a fault has occurred in the protection path or a state in which an operator has forcibly set the protection path to non-operation. In this way, the transmission bandwidth of virtual concatenation signal 29 increases and decreases.

User interface 27 transmits and receives virtual concatenation signals to and from a user device (not shown in the figure).

Explanation next regards the operation of node 11 of the present embodiment.

In FIG. 2, half of the SDH paths that are accommodated in SDH interfaces 21 and 22 are working paths, and the remaining half are protection paths. In this case, the SDH paths that are accommodated in SDH interface 21 are working paths, and the SDH paths that are accommodated in SDH interface 22 are protection paths. In the normal state of protection control, normal working SDH paths are in use, and protection SDH paths are normal but still unused and in a standby state. During this time, protection SDH paths are concatenated together with working SDH paths to produce the virtual concatenation signal.

In FIG. 2, the two SDH paths of SDH interface 21 and the two SDH paths of SDH interface 22 are concatenated by concatenation processor 25 and then connected to user interface 27 as virtual concatenation signal 29. In other words, virtual concatenation signal 29 in the normal state has the transmission bandwidth of four SDH paths 28.

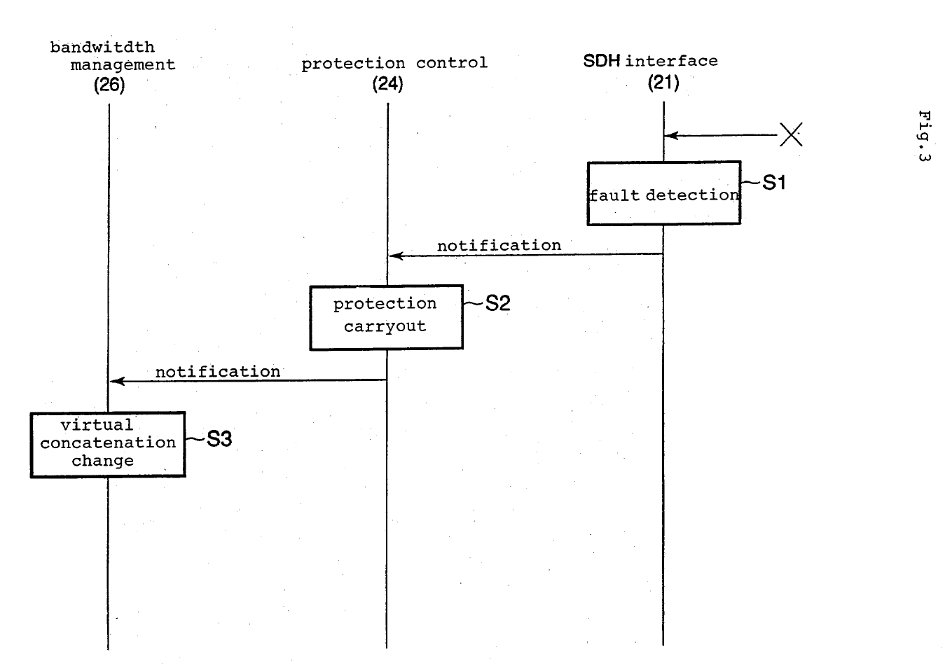

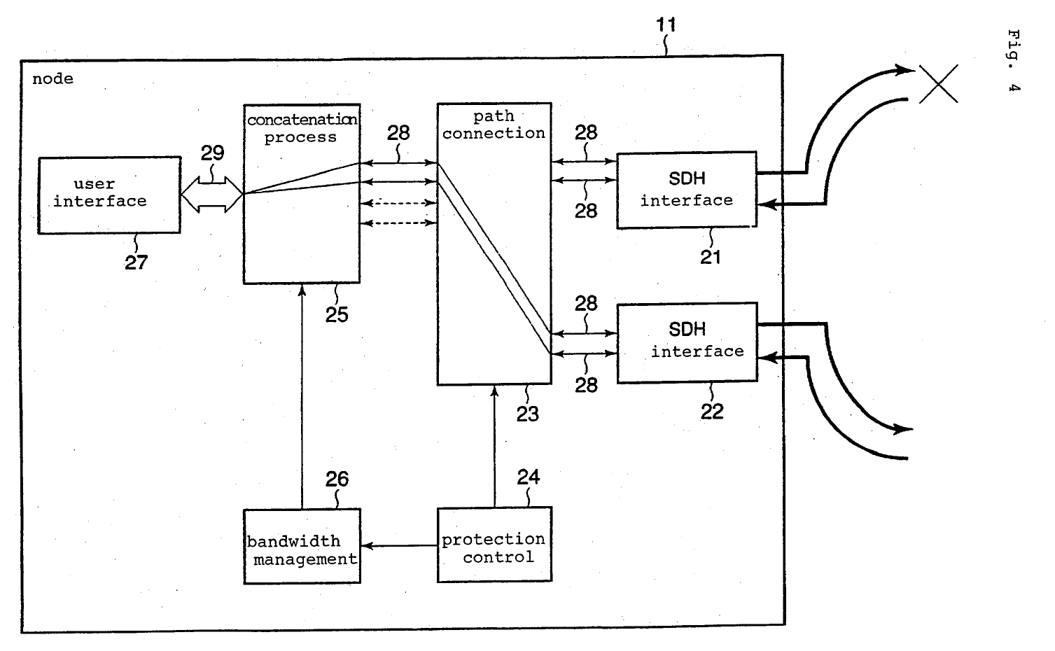

FIG. 3 is a sequence chart showing the operation of each part of node 11 when protection is executed due to the occurrence of a fault in the transmission paths. FIG. 4 shows the state of operation of node 11 when executing protection due to a fault in a transmission path.

Referring to FIG. 3, it will be assumed that a fault has occurred in a transmission path that is connected to SDH interface 21, as shown in FIG. 4. SDH interface 21 detects the fault in the transmission path and notifies protection control unit 24 of the fault (Step S1).

Protection control unit 24, upon receiving the notification of the transmission path fault from SDH interface 21, instructs path connection unit 23 to connect the protection SDH path to concatenation processor 25 in place of the failed working SDH path that is set as the transmission path (Step S2). When protection has been executed by path connection unit 23 in accordance with the instructions of protection control unit 24, the path connections are as shown in FIG. 4. in this way, the protection SDH path is used in place of the working SDH path and is therefore neither in a normal or standby state.

Protection control unit 24 further reports the execution of protection to bandwidth management unit 26. In actuality, protection is completed with the notification of the state following execution of protection to the partner node, but in the interest of simplifying the explanation, this step is omitted in FIG. 3.

Upon receiving notification of the execution of protection from protection control unit 24, bandwidth management unit 26 instructs concatenation processor 25 to delete the SDH path that, due to the execution of protection, can no longer be used as a constituent element from virtual concatenation signal 29 (Step S3). This process reduces the transmission bandwidth of virtual concatenation signal 29.

Although the transmission bandwidth of the virtual concatenation signal is consequently reduced, virtual concatenation is realized by concatenating only SDH paths that are available for service, and service can be maintained.

In FIGS. 3 and 4, a case was shown in which working SDH path and protection SDH path could not be concatenated in a virtual concatenation signal due to the execution of protection that was brought about by a fault in a working SDH path. The occurrence of a fault in a protection SDH path also prevents the use of the protection SDH path as a constituent element of virtual concatenation. In this case, the instruction from protection control unit 24 to path connection unit 23 maintains the connection of the SDH path from SDH interface 21 to concatenation processor 25 and cuts off only the SDH path from SDH interface 22. The instruction from bandwidth management unit 26 to concatenation processor 25 is to delete the SDH paths that can no longer be used from virtual concatenation signal 29.

The bandwidth of the virtual concatenation signal is also reduced as described hereinabove when an operator forcibly switches an SDH path or places SDH interface 22 or a protection SDH path in a state of halted operation. In other words, a protection SDH path can be incorporated in virtual concatenation signal 29 when it is in a normal state and free of faults, and moreover, in a standby state and not being used in protection control. In the end, the use of a protection SDH path in place of a working SDH path in protection control makes the protection SDH path a constituent element of a virtual concatenation signal. In this case, the working SDH path is dropped as a constituent element of the virtual concatenation signal.

In addition, when recovery from a transmission path fault is detected by SDH interface 21 and reported to protection control unit 24, protection control unit 24 returns the path connections to the original state (refer to FIG. 2). The protection SDH path thus returns to a state of possible use as a constituent element of virtual concatenation. When the protection SDH path enters the state of possible use, bandwidth management unit 26 instructs concatenation processor 25 to take the protection SDH path as a constituent element of virtual concatenation (refer to FIG. 2), whereby virtual concatenation signal 29 again attains the original expanded transmission bandwidth.

As described in the foregoing explanation, node 11 of the present embodiment enables the efficient use of the transmission bandwidth by using protection SDH paths as constituent elements of virtual concatenation during normal operation, and when a fault occurs in a working SDH path, both uses protection SDH paths in place of working SDH paths in protection control and dynamically reconstitutes the virtual concatenation signal using only SDH paths that can normally be used to maintain service. Node 11 of the present embodiment therefore enables both efficient use of the transmission bandwidth and reliability of the transmission paths.

Explanation next regards another embodiment of the present invention.

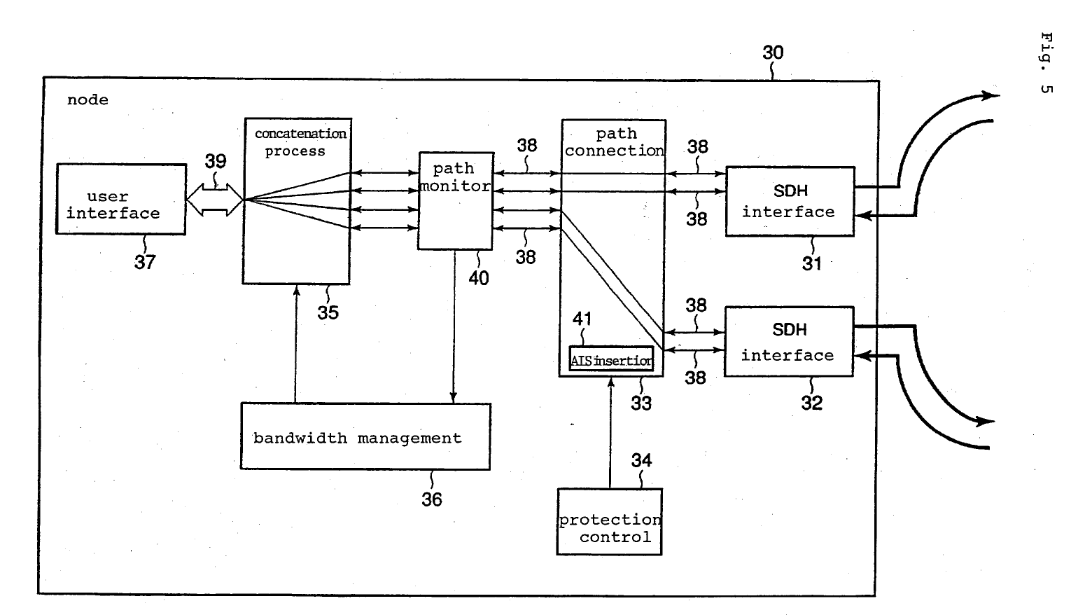

In this embodiment of the present invention, the network system is again assumed to be an MS-SPRING SDH ring system. FIG. 5 is a block diagram showing a node of this embodiment of the present invention. Referring to FIG. 5, node 30 includes: SDH interfaces 31 and 32, path connection unit 33, protection control unit 34, concatenation processor 35, bandwidth management unit 36, user interface 37, and path monitor unit 40. SDH interfaces 31 and 32, concatenation processor 35, and user interface 37 each have the same configuration as SDH interfaces 21 and 22, concatenation processor 25, and user interface 27, respectively, that were shown in FIG. 2.

Path connection unit 33, although similar to path connection unit 23 shown in FIG. 2, differs in that it further includes AIS insertion unit 41. AIS insertion unit 41 sends an AIS (Alarm Indication Signal) in place of SDH paths from SDH interfaces 31 and 32 that can no longer be connected to path monitor unit 40 when connections are altered in accordance with instructions from protection control unit 34. Protection control unit 34 determines whether or not protection is to be executed, as with protection control unit 24 of FIG. 2, but does not need to report the execution of protection to bandwidth management unit 36.

Bandwidth management unit 36 instructs concatenation processor 35 to concatenate SDH paths 38, as with bandwidth management unit 26 in FIG. 2. However, bandwidth management unit 36 is notified of the data line on which an AIS is received from path monitor unit 40 without receiving the notification of protection execution from protection control unit 34, and instructs concatenation processor 35 to delete the SDH paths that were connected to the data line on which the AIS is received from the virtual concatenation signal.

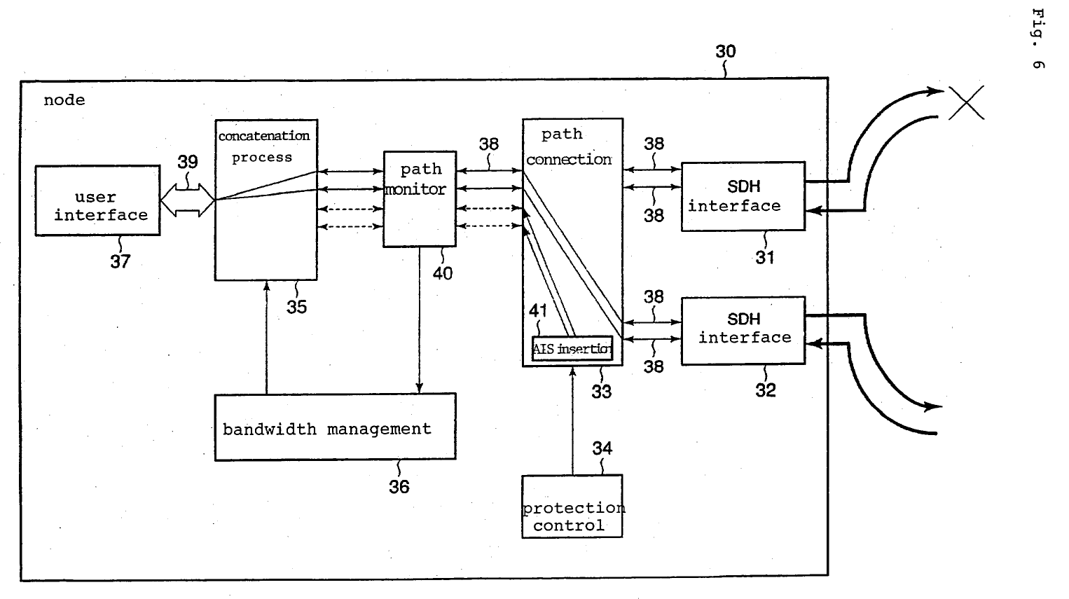

The function of path monitor unit 40 is not present in FIG. 2, this function being to monitor the SDH paths from path connection unit 33 and detect AIS. If a data line exists on which an AIS is received from path connection unit 33, path monitor unit 40 notifies bandwidth management unit 36 of this data line. Explanation next regards the operation of the node of FIG. 5. FIG. 6 shows the operating state of node 30 when protection is executed due to the occurrence of a fault on a transmission path.

It is first assumed that a fault occurs on a transmission path that is connected to SDH interface 31 as shown in FIG. 6. SDH interface 31 detects the fault in the transmission path and notifies protection control unit 34 of the fault.

Protection control unit 34, upon receiving the notification of the transmission path fault from SDH interface 31, instructs path connection unit 33 to connect a protection SDH path to path monitor unit 40 in place of the SDH path that has failed. When protection is executed at path connection unit 33 in accordance with the instruction from protection control unit 34, the path connections are as shown in FIG. 6. The protection SDH path is thus no longer available as a constituent element of virtual concatenation signal 39. In addition, an AIS is transmitted to path monitor unit 40 on a data line that, until this point, had been connected to SDH interface 32. This process is well known as a squelch process in ring systems.

Path monitor unit 40 reports the data line on which the AIS was detected to bandwidth management unit 36. Based on the notification from path monitor unit 40, bandwidth management unit 36 instructs concatenation processor 35 to delete SDH paths on which the AIS was detected from virtual concatenation signal 39, whereby the transmission bandwidth of virtual concatenation signal 39 is reduced.

As a result, virtual concatenation is realized by concatenating only those SDH paths that are available for service, and service is maintained.

Further, when the recovery from the transmission path fault is detected by SDH interface 31 and reported to protection control unit 34, protection control unit 34 returns the path connections to the original state (refer to FIG. 5), whereby the protection SDH paths become available for use as constituent elements of virtual concatenation. The AIS ends when the protection SDH paths become available for use, and the end of AIS is reported from path monitor unit 40 to bandwidth management unit 36. Bandwidth management unit 36 instructs concatenation processor 35 to take the protection SDH paths as constituent elements of virtual concatenation (see FIG. 5), whereby virtual concatenation signal 39 again attains the original expanded transmission bandwidth.

A case has been described in which a protection SDH path is used in place of a working SDH path due to the execution of protection arising from the occurrence of a fault in the working transmission path, and the concatenation of the protection SDH path with working SDH paths to broaden the bandwidth of a virtual concatenation signal is therefore prevented. In addition to this case, a protection SDH path becomes unavailable for use as a constituent element of virtual concatenation in a case in which a fault occurs on a protection transmission path. The bandwidth of a virtual concatenation signal is also reduced in cases in which an operator forcibly switches the SDH path or a protection SDH path placed in a non-operating state. In other words, a protection SDH path can be incorporated in virtual concatenation signal 39 when it is in a normal state that is free of faults, and moreover, in a standby state and not in use due to protection switching. AIS insertion unit 41 transmits AIS in place of SDH paths from SDH interfaces 31 and 32, which cannot connect to path monitor unit 40 in any of these cases.

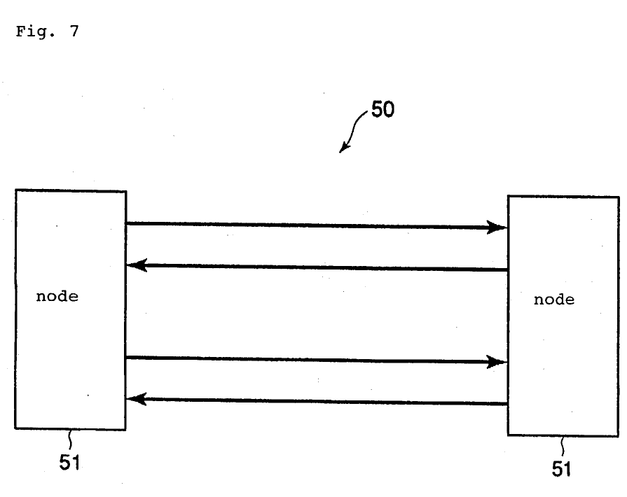

Explanation next regards another embodiment of the present invention. The network system of this embodiment of the present invention is a linear system and not a ring system. FIG. 7 is a block diagram showing the network system of this embodiment of the present invention. Referring to FIG. 7, network system 50 includes two nodes 51, both nodes 51 being of the same configuration.

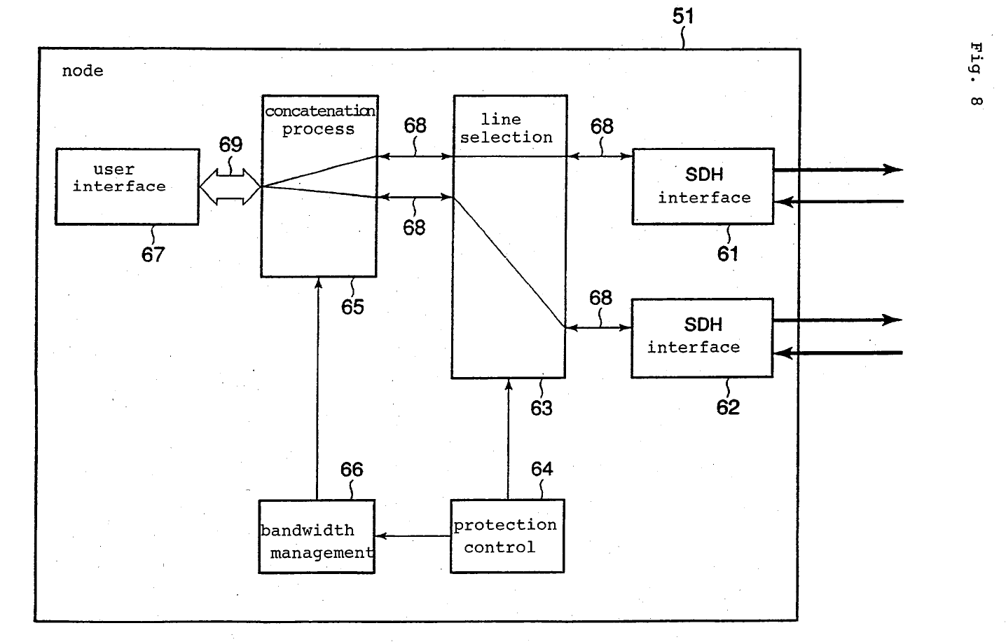

FIG. 8 is a block diagram showing the configuration of node 51 that is shown in FIG. 7. Referring to FIG. 8, node 51 includes: SDH interface 61 and 62, line selection unit 63, protection control unit 64, concatenation processor 65, bandwidth management unit 66, and user interface 67.

SDH interfaces 61 and 62 interface with other neighboring nodes and transmit on SDH lines having a plurality of SDH paths with other nodes. The SDH lines that are received at SDH interfaces 61 and 62 are supplied to line selection unit 63. SDH lines from line selection unit 63 are transmitted from SDH interfaces 61 and 62.

In addition, SDH interfaces 61 and 62 monitor information of the SDH overhead and the state of the transmission paths for the receiving side of the transmission paths. SDH interfaces 61 and 62 then send the state of each of the transmission paths and information of the SDH overhead that is used in protection protocol (hereinbelow referred to as “protection information”) to protection control unit 64.

SDH interfaces 61 and 62 further, upon receiving notification of protection execution from protection control unit 64, report this notification as protection information to other adjacent nodes. Line selection unit 63 connects SDH interfaces 61 and 62 and concatenation processor 65 in units of SDH lines 68 in accordance with line setting information from the host operating system (not shown in the figures). Line selection unit 63 also modifies connections in accordance with instructions from protection control unit 64.

Protection control unit 64 determines whether or not to execute protection based on the protection information and the state of each of the transmission paths that have been received from SDH interfaces 61 and 62. When protection is to be executed, protection control unit 64 instructs the execution of protection (i.e., the alteration of connections) to line selection unit 63 and reports the execution of protection to SDH interfaces 61 and 62 and bandwidth management unit 66. The protection that is executed here is, for example, linear protection. Linear protection is an operation of switching in units of SDH lines from working to protection between two partner nodes. This case is assumed to be a 1+1 redundancy configuration that one protection SDH line is prepared to one working SDH line. But, n+1 redundancy configuration is available. Furthermore, n+m(n>=m) redundancy configuration is available. Concatenation processor 65 concatenates the SDH paths that are included within the plurality of SDH lines 68 between concatenation processor 65 and line selection unit 63 in accordance with instructions from bandwidth management unit 66 and constructs virtual concatenation signal 69 between concatenation processor 65 and user interface 67.

Based on the information that is notified from protection control unit 64, bandwidth management unit 66 instructs concatenation processor 65 to concatenate the SDH lines that are included in SDH lines 68, whereby the transmission bandwidth of virtual concatenation signal 69 is increased.

User interface 67 transmits a virtual concatenation signal to and receives a virtual concatenation signal from user devices (not shown in the figures).

Explanation next regards the operation of node 51 of the present embodiment.

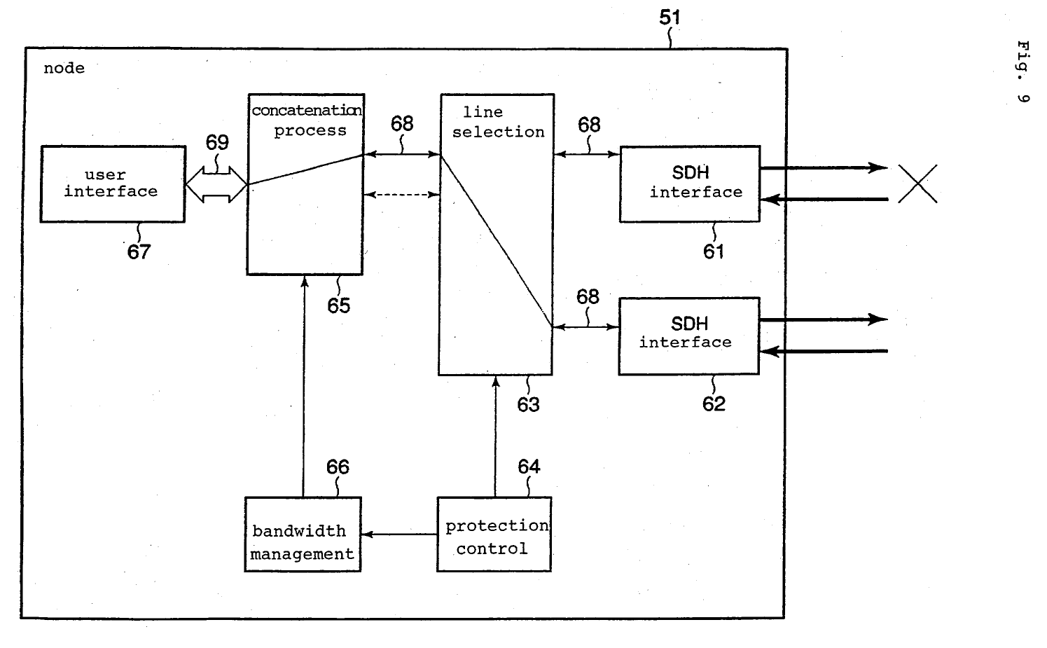

In FIG. 8, the SDH lines accommodated in SDH interface 61 are assumed to be working lines, and the SDH lines that are accommodated in SDH interface 62 are assumed to be protection lines. In the normal state of protection control, normal working SDH lines are in use and protection SDH lines are in a normal but unused standby state. At this time, the SDH paths that are included in protection SDH lines are concatenated by means of virtual concatenation together with SDH paths that are included in the working SDH lines. FIG. 9 shows the operating state of node 51 when executing protection due to the occurrence of a fault in a transmission path.

First, a fault is assumed to occur in a transmission path that is connected to SDH interface 61 as shown in FIG. 9. SDH interface 61 detects the fault in the transmission path and reports the detection to protection control unit 64.

Protection control unit 64, having received the notification of a transmission path fault from SDH interface 61, instructs line selection unit 63 to connect the SDH line of the protection transmission path to concatenation processor 65 in place of the SDH line of the transmission path in which the fault occurred. When protection is executed in line selection unit 63 in accordance with the instruction of protection control unit 64, the connections of the SDH lines are as shown in FIG. 9. The protection SDH line is thus used in place of the working SDH line and is no longer in the normal standby state, and accordingly, the concatenation of SDH paths that are included in the protection SDH line with SDH paths that are included in the working SDH line to expand the transmission bandwidth is no longer possible. Bandwidth management unit 66, upon receiving notification of the execution of protection from protection control unit 64, instructs concatenation processor 65 to delete the SDH paths that can no longer be used as constituent elements due to the execution of protection from virtual concatenation signal 69, whereby the transmission bandwidth of virtual concatenation signal 69 is reduced, but service is maintained.

When recovery from the transmission path fault is detected in SDH interface 61 and reported to protection control unit 64, protection control unit 64 returns the line connections to the original state (see FIG. 8), whereby SDH paths that are included in the protection SDH line enter a state of potential use as constituent elements of virtual concatenation. When the protection SDH line is in a useable state, bandwidth management unit 66 instructs concatenation processor 65 to treat the SDH paths that are included in the protection SDH line as constituent elements of virtual concatenation (refer to FIG. 8), whereby virtual concatenation signal 69 again returns to the original expanded transmission bandwidth. While preferred embodiments of the present invention have been described using specific terms, such description is for illustrative purposes only, and it is to be understood that changes and variations may be made without departing from the spirit or scope of the following claims.

What is claimed is:

1. A method of setting transmission routes in a transmitting device that forms a part of a network that applies: a virtual concatenation process for concatenating a plurality of paths to construct a single transmission bandwidth; and protection control for selecting paths that are used in accordance with the state of each of said paths in a redundancy configuration that is realized by a plurality of paths; said method comprising steps of:
setting working paths and protection paths in accordance with prescribed settings;
incorporating the protection paths in a virtual concatenation signal that includes said working paths if said protection paths are in a normal standby state in said protection control;
deleting the protection paths from said virtual concatenation signal if said protection paths are in an unusable state in said protection control; and
reconstructing said virtual concatenation signal from only those protection paths if said protection paths are in a state of use in said protection control.

2. A method of setting a transmission route according to claim 1, wherein said network is a ring network and said protection control is ring protection control.

3. A method of setting transmission routes in a transmission device that forms a part of a network that applies: a virtual concatenation process for concatenating paths that are included in a plurality of lines to construct a single transmission bandwidth; and protection control for selecting lines to use in accordance with the state of each of said lines in a redundancy configuration that is realized by a plurality of lines; said method comprising steps of:
setting working lines and protection lines in accordance with prescribed settings;
incorporating paths that are included in the protection lines in a virtual concatenation signal that includes paths that are included in said working lines if said protection lines are in a normal standby state in said protection control;
deleting paths that are included in the protection lines from said virtual concatenation signal if said protection lines are in an unusable state in said protection control; and
reconstructing said virtual concatenation signal from only paths that are included in these protection lines if said protection lines are in a state of use in said protection control.

4. A method of setting transmission routes according to claim 3, wherein said protection control is 1+1 linear protection control.

5. A method of setting transmission routes in a transmission device that forms a part of a network having route selection control of a redundancy configuration that is realized by a plurality of transmission routes; said method comprising steps of:
setting working transmission routes and protection transmission routes in accordance with prescribed settings;
concatenating said protection transmission routes and said working transmission routes if said protection transmission routes are in a normal standby state in said route selection control; and
releasing the concatenation of said working transmission routes and said protection transmission routes if said protection transmission routes are in an unusable state or used state in said route selection control.

6. A transmission device that forms part of a network that applies a virtual concatenation process for concatenating a plurality of paths to form a single transmission bandwidth and protection control for selecting paths to use in accordance with the state of each of said paths in a redundancy configuration that is realized by a plurality of paths; said transmission device comprising:
a protection control means for executing said protection control over predetermined working paths and protection paths and selecting and using one of said paths; and
a bandwidth management means for receiving the states of said working paths and said protection paths from said protection control means; incorporating protection paths in a virtual concatenation signal that includes said working paths if said protection paths are in a normal standby state, and
reconstructing said virtual concatenation signal from only paths that are selected by said protection control means if said protection paths are in an unusable state or an used state.

7. A transmission device according to claim 6, further comprising:
a path connection means for receiving said working paths and said protection paths as input and switching connections of paths in accordance with control from said protection control means; and
a concatenation processing means for constructing said virtual concatenation signal in accordance with instructions from said bandwidth management means.

8. A transmission device according to claim 7, further comprising at least one first interface for accommodating lines that include said working paths or said protection paths and that is connected to said path connection means.

9. A transmission device according to claim 8, further comprising a second interface for transmitting to and receiving from a user device a virtual concatenation signal that is formed by said concatenation processing means.

10. A transmission device according to claim 6, wherein said network is a ring network, and said protection control is ring protection control.

11. A transmission device that forms part of a network that applies a virtual concatenation process for concatenating a plurality of paths to form a single transmission bandwidth and protection control for selecting paths to use in accordance with the state of each of said paths in a redundancy configuration that is realized by a plurality of paths; said transmission device comprising:
a protection control means for executing said protection control over predetermined working paths and protection paths and selecting and using one of said paths;
an Alarm Indication Signal insertion means for inserting an Alarm Indication Signal in place of said protection paths when said protection paths are selected by said protection control means and used in place of said working paths, or when said protection paths are in an unusable state;
a path monitor means for detecting paths in which said Alarm Indication Signal has been inserted; and
a bandwidth management means for incorporating said protection paths in a virtual concatenation signal that includes said working paths if said Alarm Indication Signal is not detected in said path monitor means, and if said Alarm Indication Signal is detected, deleting paths in which said Alarm Indication Signal has been detected from said virtual concatenation signal.

12. A transmission device according to claim 11, further comprising:
a path connection means for receiving said working paths and said protection paths as input and switching connections of paths in accordance with control from said protection control means; and
a concatenation processing means for constructing said virtual concatenation signal in accordance with instructions from said bandwidth management means.

13. A transmission device according to claim 12, further comprising at least one first interface for accommodating lines that include said working paths or said protection paths and that is connected to said path connection means.

14. A transmission device according to claim 13, further comprising a second interface for transmitting to and receiving from a user device a virtual concatenation signal that is formed by said concatenation processing means.

15. A transmission device according to claim 11, wherein said network is a ring network, and said protection control is ring protection control.

16. A transmission device that forms part of a network that applies a virtual concatenation process for concatenating paths that are included in a plurality of lines to construct a single transmission bandwidth and protection control for selecting lines to use in accordance with the state of each of said lines in a redundancy configuration that is realized by a plurality of lines, said transmission device comprising:
a protection control means for executing said protection control over predetermined working lines and protection lines and selecting and using one of said lines; and
a bandwidth management means for receiving the states of said working lines and said protection lines from said protection control means, incorporating paths that are included in said protection lines in a virtual concatenation signal that includes paths that are included in said working line if said protection line is in a normal standby state, and reconstructing said virtual concatenation signal from only paths that are selected by said protection control means if said protection line is in an unusable state or in an used state.

17. A transmission device according to claim 16, further comprising:
a line connection means for receiving said working lines and said protection lines as input and switching connections of lines in accordance with control from said protection control means; and
a concatenation processing means for constructing said virtual concatenation signal in accordance with instructions from said bandwidth management means.

18. A transmission device according to claim 17, further comprising a plurality of first interfaces that are connected to said line connection means for accommodating each of said working lines or said protection lines.

19. A transmission device according to claim 18, further comprising a second interface for transmitting to and receiving from a user device a virtual concatenation signal that is constructed by said concatenation processing means.

20. A transmission device according to claim 16, wherein said protection control is linear protection control.

21. A transmission device that forms part of a network having the function of selecting routes of a redundancy configuration realized by a plurality of transmission routes; said transmission device comprising:
a route selection means for selecting routes to use from predetermined working transmission routes and protection transmission routes; and
a bandwidth management means for concatenating said protection transmission routes with said working transmission routes if said protection transmission routes are in a normal state and moreover, are not selected by said route selection means, and releasing concatenation of said protection transmission routes with said working transmission routes if said protection transmission routes are selected by said route selection means or are in an unusable state.

22. A network system that applies a virtual concatenation process for concatenating a plurality of paths to construct a single transmission bandwidth and protection control for selecting paths to use in accordance with the state of each of said paths in a redundancy configuration that is realized by a plurality of paths, said network system comprising: a plurality of transmission devices for executing said protection control over predetermined working paths and protection paths to select one of said paths, incorporating protection paths in a virtual concatenation signal that includes said working paths in said virtual concatenation process if said protection paths are in a normal standby state in said protection control, and reconstructing said virtual concatenation signal only from paths that have been selected by said protection control if said protection paths are in an unusable state or in a used state; and a plurality of transmission routes for interconnecting said transmission devices and for accommodating said working paths or said protection paths.

23. A network system according to claim 22, wherein said network is a ring network and said protection control is ring protection control.

24. A network system that applies a virtual concatenation process for concatenating paths that are included in a plurality of lines to construct a single transmission bandwidth and protection control for selecting lines to use in accordance with the state of each of said lines in a redundancy configuration that is realized by a plurality of lines, said network system comprising:
a plurality of transmission devices for executing said protection control over prescribed working lines and protection lines to select one of said lines, incorporating paths that are included in said protection lines in a virtual concatenation signal that includes paths that are included in said working lines in said virtual concatenation process if said protection lines are in a normal standby state, and reconstructing said virtual concatenation signal only from paths that are included in lines that have been selected by said protection control if said protection lines are in an unusable state or in a state of use; and
a plurality of transmission routes for interconnecting said transmission devices and for accommodating said working lines or said protection lines.

25. A network system according to claim 24, wherein said protection control is linear protection control.
